(19) United States
(12) Patent Application Publication
(10) Pub. No.: US 2023/0401898 A1
(43) Pub. Date: Dec. 14, 2023

(54) HAND DETECTION DEVICE, GESTURE RECOGNITION DEVICE, AND HAND DETECTION METHOD

(71) Applicant: Mitsubishi Electric Corporation, Tokyo (JP)

(72) Inventors: Shogo HOTEN, Tokyo (JP); Takuya MURAKAMI, Tokyo (JP); Daiki HIGUCHI, Tokyo (JP)

(73) Assignee: Mitsubishi Electric Corporation, Tokyo (JP)

(21) Appl. No.: 18/036,344

(22) PCT Filed: Jan. 21, 2021
(86) PCT No.: PCT/JP2021/002016

§ 371 Date: May 10, 2023

(51) Int. Cl. G06V 40/20; G06V 10/98; G06V 10/60; G06V 10/74; G06V 10/26; G06V 10/50; G06V 20/59

(52) U.S. Cl. CPC G06V 40/28; G06V 10/98; G06V 10/60; G06V 10/761; G06V 10/267; G06V 10/50; G06V 20/59

(57) ABSTRACT

In the hand detection device, an image acquisition unit acquires an image for hand detection, which is an image obtained by capturing a hand detection region in a vehicle. A luminance difference calculation unit calculates an inter-frame luminance difference of the image for hand detection. A hand detection unit detects a hand of a user from the image for hand detection. An erroneous detection determination unit determines whether or not the detected hand has been erroneously detected on the basis of the luminance difference between the frame in which the hand has been detected and the frame immediately preceding thereof in the hand detection area.

### TECHNICAL FIELD

The present disclosure relates to a technique to detect a hand of a user, and more particularly to a technique to detect a hand of the user from a captured in-vehicle image.

### BACKGROUND ART

A gesture recognition device has been known that recognizes a gesture made by a hand of a user (so-called “hand gesture”) by detecting the hand of the user from an image captured by a camera and recognizing the shape of the detected hand. For example, in Patent Document 1 below, attempts are made to prevent erroneous detection and improve the detection rate of a hand of a user by limiting the area used for hand detection in an image captured by a camera.

### PRIOR ART DOCUMENTS

### Patent Document(s)

[Patent Document 1] Japanese Patent Application Laid-Open No. 2009-064199

### SUMMARY

### Problem to be Solved by the Invention

When a gesture recognition device is applied to the recognition of gesture operations of an in-vehicle device, the main user is represented by an occupant in a driver's seat (driver) or an occupant in a passenger seat. for this reason, setting an area for the detection of a hand in an in-vehicle image (hand detection region) to an area between the driver's seat and the passenger seat is to be considered. However, there has been concern that objects other than the hand of the user, such as passengers in the backseat and luggage placed in the backseat may appear in the area between the driver's seat and the passenger seat, and may be erroneously detected such objects as the hand of the user.

The present disclosure has been made to solve the problem described above, and an object of the present disclosure is to provide a hand detection device that accurately detects a hand of a user from an in-vehicle image.

### Means to Solve the Problem

A hand detection device according to the present disclosure includes an image acquisition unit configured to acquire an image for hand detection, which is an image obtained by capturing a hand detection region inside a vehicle, a luminance difference calculation unit configured to calculate an inter-frame luminance difference of the image for hand detection, a hand detection unit configured to detect a hand of a user from the image for hand detection, and an erroneous detection determination unit configured to determine whether or not the detected hand has been erroneously detected on the basis of the luminance difference between a frame in which the hand has been detected and a frame immediately preceding thereof in the image for hand detection.

### Effects of the Invention

According to the hand detection device according to the present disclosure, erroneous detection of the hand can be detected, which ensures accurate detection of a hand of a user from an in-vehicle image.

The objects, features, aspects, and advantages of the present disclosure will become more apparent from the following detailed description and the accompanying drawings.

### BRIEF DESCRIPTION OF DRAWINGS

FIG. 1 A diagram illustrating a configuration of a hand detection device and a gesture recognition device according to first to third embodiments.

FIG. 2 A diagram illustrating an example of an in-vehicle image and a hand detection region.

FIG. 3 A diagram illustrating an example of an in-vehicle image and a hand detection region.

FIG. 4 A flowchart illustrating operation of a gesture recognition device according to the first to the third embodiments.

FIG. 5 A flowchart illustrating an erroneous detection determination process according to the first embodiment.

FIG. 6 A flowchart illustrating an erroneous detection determination process according to the second embodiment.

FIG. 7 A flowchart illustrating an erroneous detection determination process according to the third embodiment.

FIG. 8 A diagram illustrating a hardware configuration example of the hand detection device.

FIG. 9 A diagram illustrating a hardware configuration example of the hand detection device.

### DESCRIPTION OF EMBODIMENT(S)

### First Embodiment

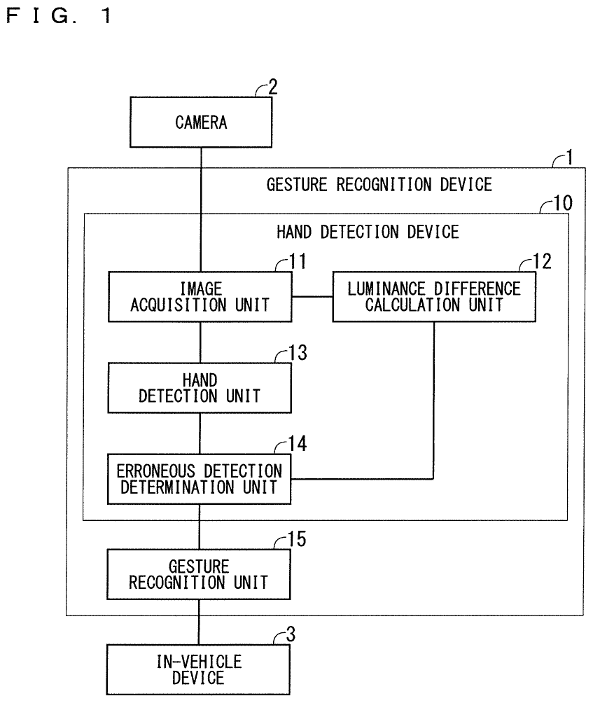

FIG. 1 is a diagram illustrating a configuration of a gesture recognition device 1 according to a first embodiment. In the first embodiment, it is assumed that the gesture recognition device 1 is mounted on a vehicle. However, the gesture recognition device 1 may not be permanently installed in the vehicle, and may be constructed on a portable device such as a cell phone or a smartphone that can be brought into the vehicle. Also, part of the functions of the gesture recognition device 1 may be built on a server installed outside the vehicle and capable of communicating with the gesture recognition device 1.

A gesture recognition device 1 is connected to a camera 2 that captures an in-vehicle image, and an in-vehicle device 3 such as a navigation device, an audio device, and an air conditioner. The gesture recognition device 1 also includes a hand detection device 10 that detects a hand of a user from an image captured by a camera 2, and a gesture recognition unit 15 that recognizes a gesture (a hand gesture) made by the hand of the user detected by the hand detection device 10 and outputs the recognition result to the in-vehicle device 3. The operation of the in-vehicle device 3 is controlled on the basis of the gesture recognized by the gesture recognition unit 15. Therefore, the user can perform a gesture operation of the in-vehicle device 3 through the gesture recognition device 1.

Any gesture recognition method may be adoptable to the gesture recognition unit for example, a method of recognizing gestures by pattern matching between the detected shape of the hand of the user and a template prepared in advance, a method of recognizing gestures by determining the shape of the hand of the user from arbitrary feature values extracted from an in-vehicle image, and the like, are considered as such a method. Note that the gesture recognized by the gesture recognition unit 15 may be any of a gesture made by the shape of the hand, a gesture made by the movement of the hand, and a gesture made by both the shape and movement of the hand.

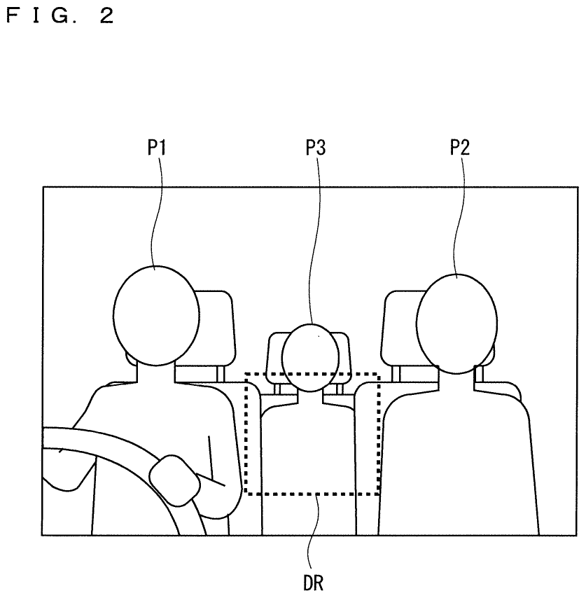

In the present embodiment, it is assumed that the users of the gesture recognition device 1, that is, the subject persons whose gestures are to be recognized by the gesture recognition device 1, are occupants in the driver's seat and the passenger seat of the vehicle. In addition, the camera 2 is arranged in the central portion of the vehicle dashboard and captures an in-vehicle image in which an image of an occupant P1 (driver) in the driver's seat and an occupant P2 in the passenger seat, who are users, is included, as illustrated in FIG. 2.

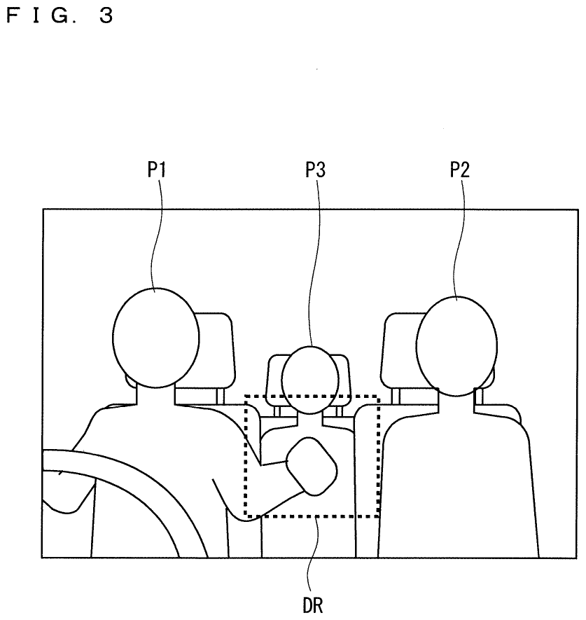

As illustrated in FIG. 2, a hand detection region DR, which is an area where a hand of the user is detected, is defined within a photographing range of the camera 2. Here, the hand detection region DR is set between the driver's seat and the passenger seat of the vehicle. Under normal conditions, the hand of the user is not within the hand detection region DR as illustrated in FIG. 2. When performing a gesture operation of the in-vehicle device 3, the user needs to put his/her hand in the hand detection region DR as illustrated in FIG. 3 to make a hand gesture. In this manner, defining the hand detection region DR as an area where the hand of the user does not come in under normal conditions ensures the suppression of erroneous detection of hand gestures.

However, when setting the hand detection region DR between the driver's seat and the passenger seat, as illustrated in FIGS. 2 and 3, an occupant P3 sitting in the rear seat may be captured in the hand detection region DR, or luggage (not illustrated) placed in the rear seat may be captured. In such a case, the occupant P3 or the luggage in the rear seat being erroneously detected by the gesture recognition device 1 as the hand of the occupant P1 in the driver's seat or of the occupant P2 in the passenger seat is required to be prevented.

As illustrated in FIG. 1, the hand detection device 10 includes an image acquisition unit 11, a luminance difference calculation unit 12, a hand detection unit 13, and an erroneous detection determination unit 14.

The image acquisition unit 11 acquires an image for hand detection, which is an image obtained by capturing the hand detection region DR, by trimming the in-vehicle image captured by the camera 2. The luminance difference calculation unit 12 calculates an inter-frame luminance difference in the image for hand detection the image acquisition unit 11 has acquired.

The hand detection unit 13 detects the hand of the user from the image for hand detection the luminance difference calculation unit 12 has acquired. Any hand detection method may be adoptable by the hand detection unit 13 and a method of detecting a hand by pattern matching between the image for hand detection and a hand image template prepared in advance, a method of detecting a hand by determining the position of the hand of the user from arbitrary feature values extracted from the image for hand detection, and the like are considered, for example.

The erroneous detection determination unit 14 determines whether or not the hand detected by the hand detection unit 13 has been erroneously detected on the basis of the inter-frame luminance difference of the image for hand detection the luminance difference calculation unit 12 has calculated. More specifically, the erroneous detection determination unit 14 determines that the hand has been correctly detected when the luminance difference between the frame in which the hand has been detected and the frame immediately preceding thereof in the image for hand detection surpasses a predetermined threshold, and determines that the hand has been erroneously detected when the luminance difference between the frame in which the hand has been detected and the frame immediately preceding thereof in the image for hand detection is lower than or equal to the threshold. The “luminance of the immediately preceding frame” used for calculating the luminance difference may be the luminance of one immediately preceding frame or the average value of the luminance of a plurality of immediately preceding frames (for example, 3 frames).

The erroneous detection determination unit 14 transmits the hand detection result by the hand detection unit 13 to the gesture recognition unit 15 when determined that the hand is correctly detected and does not transmit the hand detection result by the hand detection unit 13 to the gesture recognition unit 15 or transmits a notification of erroneous hand detection to the gesture recognition unit 15 when determined that the hand is erroneously detected.

The gesture recognition unit 15 recognizes the gesture by the hand of the user on the basis of the detection result of the hand transmitted from the erroneous detection determination unit 14, that is, the detection result of the hand determined to be correctly detected. A gesture recognition result by the gesture recognition unit 15 is output to the in-vehicle device 3, and the in-vehicle device 3 is controlled on the basis of the recognition result. Accordingly, the in-vehicle device 3 operates according to the gesture operation by the user.

In the first embodiment, the luminance difference calculation unit 12 calculates an inter-frame difference of the average luminance of the image for hand detection as an inter-frame luminance difference of the image for hand detection. Also, the erroneous detection determination unit 14 determines that the hand has been correctly detected when an average luminance difference between the frame in which the hand has been detected and the frame immediately preceding thereof in the image for hand detection surpasses a predetermined threshold, and determines that the hand has been erroneously detected when the average luminance difference is lower than or equal to the predetermined threshold. For example, when the image for hand detection has 256 gradations the above threshold may be 15 or so.

As described above, under normal conditions, the hand of the user (the occupant P1 in the driver's seat and the occupant P2 in the passenger seat) is not within the hand detection region DR as illustrated in FIG. 2. When performing a gesture operation of the in-vehicle device 3, the user puts his/her hand in the hand detection region DR as illustrated in FIG. 3 to make a hand gesture. When the state where the hand of the user is not in the hand detection region DR (FIG. 2) changes to the state where the hand of the user is in the hand detection region DR (FIG. 3), the luminance of the image for hand detection, which is the image of the hand detection region DR, significantly changes. Meanwhile, the occupant P3 and the luggage in the back seat are always appear in the hand detection region DR; therefore, the occupant P3 and the luggage in the back seat are less likely to change the luminance of the image for hand detection.

Therefore, when the difference in average luminance between the frame in which the hand has been detected in the image for hand detection and the frame immediately preceding thereof surpasses the threshold, it is highly likely that the hand of the user may have put in and out of the hand detection region DR, and the hand detected from the image for hand detection is highly likely to be the hand of the user. In addition, the hand detected when the difference in average luminance between the frame in which the hand has been detected in the image for hand detection and the frame immediately preceding thereof is lower than or equal to the threshold is highly likely to be the one erroneously detected as the occupant P3 or the luggage in the back seat that appears in the hand detection region DR at all times as the hand of the user. Therefore, by the erroneous detection determination unit 14 performing the erroneous detection determination as described above, erroneous detection results can be eliminated from the detection results by the hand detection unit 13, leading to accurate detection of the hand of the user. As a result, erroneous recognition of gestures by the gesture recognition unit 15 can be prevented, and malfunction of the in-vehicle device 3 due to erroneous recognition of gestures can also be prevented.

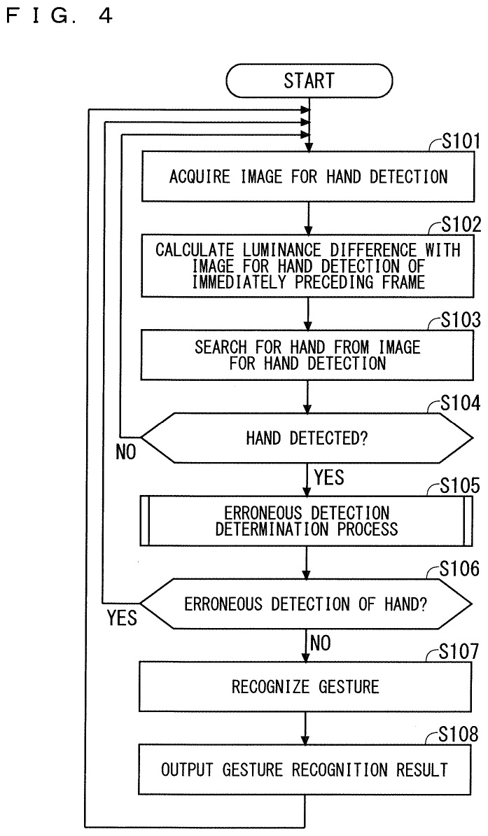

The operation of the gesture recognition device 1 will be described below on the basis of the flowchart of FIG. 4. When the gesture recognition device 1 is activated, the image acquisition unit 11 acquires an image for hand detection, which is an image obtained by capturing the hand detection region DR, by trimming the in-vehicle image captured by the camera 2 (Step S101).

Next, the luminance difference calculation unit 12 calculates the luminance difference between the image for hand detection of the latest frame and the image for hand detection of the immediately preceding frame acquired in Step S101 (Step S102). Note that in Step S102, immediately after the gesture recognition device 1 is activated, only one frame of the image for hand detection is acquired; therefore, the calculation of the luminance difference is not performed. In the present embodiment, the luminance difference calculation unit 12 calculates an inter-frame difference of the average luminance of the image for hand detection as an inter-frame luminance difference of the image for hand detection.

Then, the hand detection unit 13 searches for the hand of the user from the image for hand detection the luminance difference calculation unit 12 has acquired. When the hand is not detected at this point (NO in Step S104), the process returns to Step S101.

When a hand is detected from the image for hand detection (YES in Step S104), the erroneous detection determination unit 14 executes an erroneous detection determination process in which whether or not the hand detected by the hand detection unit 13 has been erroneously detected (Step S105) on the basis of the inter-frame luminance difference of the image for hand detection calculated by the luminance difference calculation unit 12.

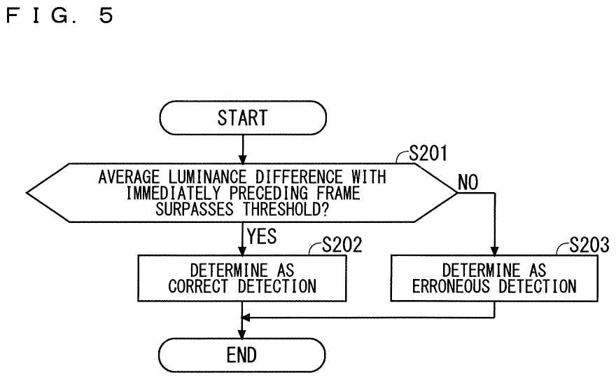

In the erroneous detection determination process, the erroneous detection determination unit 14 performs the process illustrated in the flowchart of FIG. 5. That is, the erroneous detection determination unit 14 checks whether or not the difference in average luminance between the image for hand detection of the latest frame and the image for hand detection of the immediately preceding frame surpasses the predetermined threshold (Step S201). When the difference surpasses the threshold (YES in Step S201), the erroneous detection determination unit 14 determines that the hand detected by the hand detection unit 13 has been correctly detected (Step S202). When the difference is lower than or equal to the threshold (NO in Step S201), the erroneous detection determination unit 14 determines that the hand detected by the hand detection unit 13 has been erroneously detected (Step S203).

Returning to FIG. 4, when it is determined that the detected hand has been erroneously detected as a result of the erroneous detection determination process (Step S105) (YES in Step S106), the process returns to Step S101. Further, when it is determined that the detected hand is correctly detected (NO in Step S106), the gesture recognition unit 15 recognizes the gesture made by the hand of the user on the basis of the hand detection result by the hand detection unit 13 (Step S107), and outputs the recognition result to the in-vehicle device 3 (Step S108), and the process returns to Step S101.

As described above, hand detection device 10 according to the first embodiment can eliminate erroneous detection results from the hand detection results obtained by the hand detection unit 13, leading to accurate detection of the hand of the user. As a result, erroneous recognition of gestures by the gesture recognition unit 15 of the gesture recognition device 1 can be prevented, and malfunction of the in-vehicle device 3 due to erroneous recognition of gestures can also be prevented.

In the above description, although the example has been illustrated in which the camera 2 captures a range wider than the hand detection region DR, and part of the image captured by the camera 2 is used as the image for hand detection, only the hand detection region DR may be captured by the camera 2, and the entire image captured by the camera 2 may be used as the image for hand detection.

Further, the configurations of the hand detection device 10 and gesture recognition device 1 are not limited to the example in FIG. 1. For example, the gesture recognition device 1 and the hand detection device 10 may be configured as separate devices. Also, the camera 2 may be built in the hand detection device 10 or the gesture recognition device 1. Further, the hand detection device 10 and the gesture recognition device 1 may be built in the in-vehicle device 3.

### Second Embodiment

In the first embodiment, the inter-frame difference in average luminance of the image for hand detection is used as the inter-frame luminance difference of the image for hand detection. The second embodiment illustrates an example in which an inter-frame difference of Histograms of Oriented Gradients (HOG) feature amounts of an image for hand detection is used as an inter-frame luminance difference of the image for hand detection. The HOG feature amount is a feature amount obtained by dividing an image into a plurality of blocks and histogramming the luminance gradient direction in each block.

The configurations of the hand detection device 10 and the gesture recognition device 1 of the second embodiment are the same as in FIG. 1, and their operations are the same as in FIG. 4. However, in the second embodiment, the luminance difference calculation unit 12 divides the image for hand detection into a plurality of blocks in Step S102 of FIG. 4, and calculates the inter-frame difference of the HOG feature amount of each block as the inter-frame luminance difference of the image for hand detection. Further, the erroneous detection determination unit 14 performs erroneous detection determination process (Step S105 in FIG. 4) on the basis of the difference in the HOG feature amount between the frame in which the hand has been detected and the frame immediately preceding thereof in the image for hand detection.

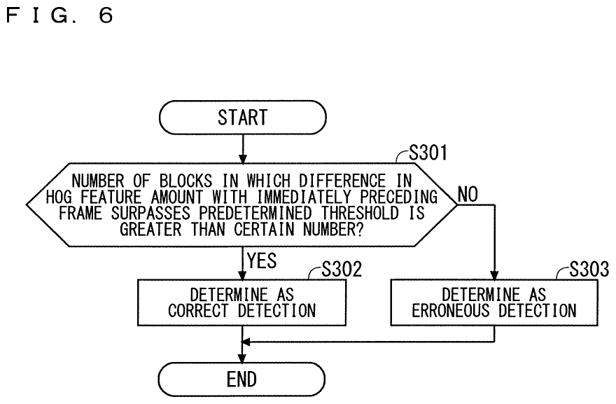

Specifically, in the erroneous detection determination process, the erroneous detection determination unit 14 performs the process illustrated in the flowchart of FIG. 6. That is, the erroneous detection determination unit 14 checks whether or not the number of blocks in which the difference in the HOG feature amount between the image for hand detection of the latest frame and the image for hand detection of the immediately preceding frame surpasses the predetermined threshold is greater than a certain number of blocks (Step S301). When the number of blocks in which the difference in the HOG feature amount surpasses the threshold is greater than the certain number (YES in Step S301), the erroneous detection determination unit 14 determines that the hand detected by the hand detection unit 13 has been correctly detected (Step S302). When the number of blocks in which the difference in the HOG feature amount surpasses the threshold is lower than or equal to the threshold (NO in Step S301), the erroneous detection determination unit 14 determines that the hand detected by the hand detection unit 13 has been erroneously detected (Step S303). For example, the threshold of the difference in the HOG feature amount may be 0.2 or so, and when the total number of blocks is nine, the certain number may be 2 or so.

As with the first embodiment, the hand detection device 10 according to the second embodiment can also eliminate erroneous detection results from the hand detection results obtained by the hand detection unit 13, leading to accurate detection of the hand of the user. As a result, erroneous recognition of gestures by the gesture recognition unit 15 of the gesture recognition device 1 can be prevented, and malfunction of the in-vehicle device 3 due to erroneous recognition of gestures can also be prevented.

In the case where the operation of the hand detection device 10 becomes unstable due to the determination of the excessive erroneous detection with the erroneous detection determination process illustrated in FIG. 6, the rate of the detected hand being determined to be erroneously detected may be temporarily lowered after the erroneous detection determining unit 14 determines that the hand has been correctly detected. For example, after the erroneous detection determination unit 14 has determined that the hand has been correctly detected, the erroneous detection determination unit 14 may determine that the hand detected from the image for hand detection is correctly determined until the frame in which the number of blocks in which the difference in the HOG feature amount with the immediately preceding frame surpasses the threshold is lower than or equal to the certain number appears predetermined times (for example 5 times) in succession.

### Third Embodiment

In the third embodiment, an example of the first embodiment and the second embodiment combined is illustrated. The configurations of the hand detection device 10 and the gesture recognition device 1 of the third embodiment are the same as in FIG. 1, and their operations are the same as in FIG. 4.

However, in the third embodiment, the luminance difference calculation unit 12 divides the image for hand detection into a plurality of blocks in Step S102 of FIG. 4, and calculates the inter-frame difference of the HOG feature amount of each block and the inter-frame difference in average luminance of the image for hand detection as the inter-frame luminance differences of the image for hand detection. Further, the erroneous detection determination unit 14 performs erroneous detection determination process (Step S105 in FIG. 4) on the basis of these two luminance differences.

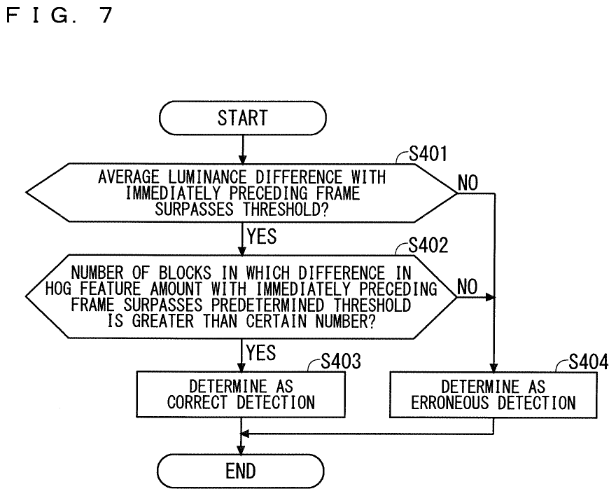

Specifically, in the erroneous detection determination process, the erroneous detection determination unit 14 performs the process illustrated in the flowchart of FIG. 7. That is, the erroneous detection determination unit 14 first checks whether or not the difference in average luminance between the image for hand detection of the latest frame and the image for hand detection of the immediately preceding frame surpasses the predetermined threshold (first threshold) (Step S401). When the difference surpasses the threshold (YES in Step S401), the erroneous detection determination unit 14 further checks whether or not the number of blocks in which the difference in the HOG feature amount between the image for hand detection of the latest frame and the image for hand detection of the immediately preceding frame surpasses the predetermined threshold (second threshold) is greater than a certain number of blocks (Step S402). When the number of blocks in which the difference surpasses the threshold is greater than the certain number (YES in Step S402), the erroneous detection determination unit 14 determines that the hand detected by the hand detection unit 13 has been correctly detected (Step S403).

Meanwhile, when the difference in average luminance between the image for hand detection of the latest frame and the image for hand detection of the immediately preceding frame is lower than or equal to the threshold (first threshold) (NO in Step S401), or when the number of blocks in which the difference in the HOG feature amount between the latest frame of the image for hand detection and the immediately preceding frame of the image for hand detection surpasses the threshold (second threshold) is lower than or equal to a certain number (NO in Step S402), the erroneous detection determination unit 14 determines that the hand detected by the hand detection unit 13 is erroneously detected (Step S404).

As with the first and second embodiments, the hand detection device 10 according to the third embodiment can also eliminate erroneous detection results from the hand detection results obtained by the hand detection unit 13, leading to accurate detection of the hand of the user. As a result, erroneous recognition of gestures by the gesture recognition unit 15 of the gesture recognition device 1 can be prevented, and malfunction of the in-vehicle device 3 due to erroneous recognition of gestures can also be prevented.

In the case where the operation of the hand detection device 10 becomes unstable due to the determination of the excessive erroneous detection with the erroneous detection determination process illustrated in FIG. 6, the rate of the detected hand being determined to be erroneously detected may be temporarily lowered after the erroneous detection determining unit 14 determines that the hand has been correctly detected. For example, after the erroneous detection determination unit 14 has determined that the hand has been correctly detected, the erroneous detection determination unit 14 may determine that the hand detected from the image for hand detection is correctly determined, until the frame in which the number of blocks in which the difference in the average luminance with the immediately preceding frame is lower than or equal to the threshold (first threshold), or the difference in the HOG feature amount with the immediately preceding frame surpasses the threshold (second threshold) is lower than or equal to the certain number appears predetermined times (for example 5 times) in succession.

<Hardware Configuration Example>

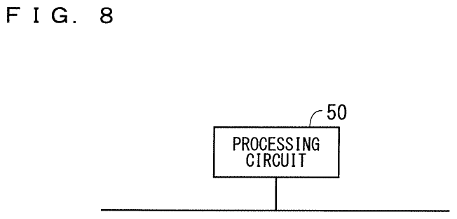

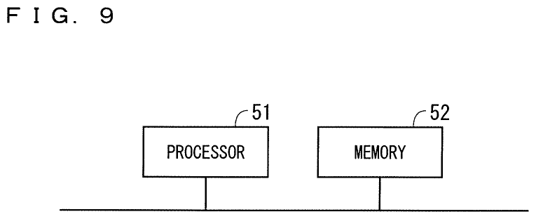

FIG. 8 and FIG. 9 are diagrams illustrating hardware configuration examples of the hand detection device. Each function of the components of the hand detection device 10 illustrated in FIG. 1 is implemented by, for example, a processing circuit 50 illustrated in FIG. 8. That is, the hand detection device 10 includes a processing circuit for acquiring an image for hand detection, which is an image obtained by capturing the hand detection region inside the vehicle, calculating the inter-frame luminance difference of the image for hand detection, detecting the hand of the user from the image for hand detection, and determining whether or not the detected hand has been erroneously detected on the basis of the luminance difference between the frame in which the hand has been detected and the frame immediately preceding thereof in the image for hand detection. The processing circuit 50 may be dedicated hardware or configured using a processor (also called a central processing unit (CPU)), a processing unit, an arithmetic unit, a microprocessor, a microcomputer, or a digital signal processor (DSP) that executes a program stored in memory.

When the dedicated hardware is applied to the processing circuit 50, a processing circuit 50 corresponds, for example, to a single circuit, a composite circuit, a programmed processor, a parallel programmed processor, an Application Specific Integrated Circuit (ASIC), or a Field-Programmable Gate Array (FPGA), or the combination thereof. Each function of the components of the hand detection device 10 may be implemented by individual processing circuits, or these functions may be collectively implemented by one processing circuit.

FIG. 9 illustrates an example of the hardware configuration of the hand detection device 10 when the processing circuit 50 is configured using a processor 51 that executes the program. In this case, the function of each unit of the hand detection device 10 is implemented in combination with software, (software, firmware, or software and firmware) etc. Software etc. is written as a program and stored in the memory 52. The function of each unit is implemented by the processing circuit 50 reading and executing the program stored in the memory 52. That is, the hand detection unit 10 includes the memory 52 storing a program in which a process of acquiring an image for hand detection, which is an image obtained by capturing the hand detection region inside the vehicle, a process of calculating an inter-frame luminance difference of the image for hand detection, a process of detecting the hand of the user from the image for hand detection, and a process of determining whether or not the detected hand has been erroneously detected on the basis of the luminance difference between the frame in which the hand has been detected and the frame immediately preceding thereof in the image for hand detection are eventually implemented when executed by the processor 51. In other words, it can be said that this program causes a computer to execute the procedures and methods of operation of the components of the hand detection device 10.

Here, the memory 52 may be, for example, a non-volatile or volatile semiconductor memory, such as a Random Access Memory (RAM), a ROM, a flash memory, an Erasable Programmable Read Only Memory (EPROM), an Electrically Erasable Programmable Read Only Memory (EEPROM), or the like, a Hard Disk Drive (HDD), a magnetic disk, a flexible disk, an optical disk, a compact disk, a digital versatile disc (DVD) and a drive therefor or the like, or any storage medium used in the future.

The configuration in which the function of each component of the hand detection device 10 is implemented by either hardware or software has been described above. However, the configuration is not limited thereto, a configuration in which some components of the hand detection device 10 are implemented by dedicated hardware and some other components are implemented by software or the like may be adoptable. For example, for some components, the functions are implemented by the processing circuit as dedicated hardware, and for some other components, the functions are implemented by the processing circuit 50 as the processor 51 reading and executing the program stored in the memory 52.

Accordingly, the hand detection device 10 can implement the above each function by hardware, software, or a combination thereof.

The embodiments can be combined, appropriately modified or omitted.

The foregoing description is in all aspects illustrative and not restrictive, and it is therefore understood that numerous modifications can be devised.

### EXPLANATION OF REFERENCE SIGNS

1 gesture recognition device, 2 cameras, 3 in-vehicle device, 10 hand detection device, 11 image acquisition unit, 12 luminance difference calculation unit, 13 hand detection unit, 14 erroneous detection determination unit, 15 gesture recognition unit, 50 processing circuit, 51 processor, 52 memory, DR hand detection region, P1 occupant in driver's seat, P2 occupant in passenger seat, P3 occupant in back seat.

1. A hand detection device comprising:
a processor to execute a program, and
a memory to store the program which, when executed by the processor, performs processes of,
acquiring an image for hand detection, which is an image obtained by capturing a hand detection region inside a vehicle;
calculating an inter-frame luminance difference of the image for hand detection;
detecting a hand of a user from the image for hand detection; and
determining whether or not the detected hand has been erroneously detected on the basis of the luminance difference between a frame in which the hand has been detected and a frame immediately preceding thereof in the image for hand detection, wherein
the processor is configured to calculate an inter-frame difference of an average luminance of the image for hand detection as a luminance difference, and
the processor is configured to determine that the hand has been erroneously detected when the difference of the average luminance between a frame in which the hand has been detected and a frame immediately preceding thereof in the image for hand detection is lower than or equal to a predetermined threshold.

2. The hand detection device according to claim 1, wherein
the image for hand detection is an image obtained by trimming a portion corresponding to the hand detection region from an image captured by a camera mounted in the vehicle.

3. The hand detection device according to claim 1, wherein
the hand detection region is a region between a driver's seat and a passenger seat in the vehicle.

4.-9. (canceled)

10. The hand detection device according to claim 1, further comprising
a camera configured to capture an image of the vehicle including the image for hand detection.

11. The hand detection device according to claim 10, wherein
the camera is arranged in a central portion of a dashboard of the vehicle.

12. A gesture recognition device comprising:
the hand detection device according to claim 1; and
a gesture recognizer configured to recognize a gesture made by the hand determined to be correctly detected.

13. A hand detection method comprising:
acquiring an image for hand detection, which is an image obtained by capturing a hand detection region inside a vehicle;
calculating an inter-frame luminance difference of the image for hand detection;
detecting a hand of a user from the image for hand detection; and
determining whether or not the detected hand has been erroneously detected on the basis of the luminance difference between a frame in which the hand has been detected and a frame immediately preceding thereof in the image for hand detection, wherein
the luminance difference is an inter-frame difference in an average luminance of the image for hand detection, and
that the hand has been erroneously detected is determined when the difference of average luminance between a frame in which the hand has been detected and a frame immediately preceding thereof in the image for hand detection is lower than or equal to a predetermined threshold.

14. A hand detection device comprising:
a processor to execute a program, and
a memory to store the program which, when executed by the processor, performs processes of,
acquiring an image for hand detection, which is an image obtained by capturing a hand detection region inside a vehicle;
calculating an inter-frame luminance difference of the image for hand detection;
detecting a hand of a user from the image for hand detection; and
determining whether or not the detected hand has been erroneously detected on the basis of the luminance difference between a frame in which the hand has been detected and a frame immediately preceding thereof in the image for hand detection, wherein
the processor is configured to divide the image for hand detection into a plurality of blocks and calculate an inter-frame difference of a Histograms of Oriented Gradients (HOG) feature amount of each block as an inter-frame luminance difference, and
the processor is configured to determine that the hand detected by the hand has been erroneously detected when the number of blocks in which the difference in the HOG feature amount between a frame in which the hand has been detected and a frame immediately preceding thereof in the image for hand detection surpasses a predetermined threshold is lower than or equal to a certain number.

15. The hand detection device according to claim 14, wherein
the image for hand detection is an image obtained by trimming a portion corresponding to the hand detection region from an image captured by a camera mounted in the vehicle.

16. The hand detection device according to claim 14, wherein
the hand detection region is a region between a driver's seat and a passenger seat in the vehicle.

17. The hand detection device according to claim 14, wherein
the processor is configured to determine that the hand detected from the image for hand detection is correctly detected, after determination of the hand having been correctly detected, until the frame in which the number of blocks in which the difference in the HOG feature amount with the immediately preceding frame surpasses the threshold is lower than or equal to the certain number appears predetermined times in succession.

18. The hand detection device according to claim 14, further comprising
a camera configured to capture an image of the vehicle including the image for hand detection.

19. The hand detection device according to claim 18, wherein
the camera is arranged in a central portion of a dashboard of the vehicle.

20. A gesture recognition device comprising:
the hand detection device according to claim 14; and
a gesture recognizer configured to recognize a gesture made by the hand determined to be correctly detected.

21. A hand detection method comprising:
acquiring an image for hand detection, which is an image obtained by capturing a hand detection region inside a vehicle;
calculating an inter-frame luminance difference of the image for hand detection;
detecting a hand of a user from the image for hand detection; and
determining whether or not the detected hand has been erroneously detected on the basis of the luminance difference between a frame in which the hand has been detected and a frame immediately preceding thereof in the image for hand detection, wherein
the luminance difference is an inter-frame difference of a Histograms of Oriented Gradients (HOG) feature amount of each block of the divided image for hand detection into a plurality of blocks, and
that the detected hand has been erroneously detected when the number of blocks in which the difference in the HOG feature amount between a frame in which the hand has been detected and a frame immediately preceding thereof in the image for hand detection surpasses a predetermined threshold is lower than or equal to a certain number.
